(19) United States
(12) Patent Application Publication
(10) Pub. No.: US 2009/0272817 A1
(43) Pub. Date: Nov. 5, 2009

(54) Method and apparatus for reducing the intensity of hurricanes at sea by deep-water upwelling

(76) Inventors: Ronald D. Blum, Roanoke, VA (US); Bradley J. Blum, Roanoke, VA (US); Dwight P. Duston, Laguna Niguel, CA (US); George M. Hagerman, JR., Alexandria, VA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/994,860

(22) Filed: Nov. 28, 2001

Related U.S. Application Data
(60) Provisional application No. 60/253,111, filed on Nov. 28, 2000.

(51) Int. Cl. A01G 15/00

(52) U.S. Cl. 239/2.1

(57) ABSTRACT

Methods and apparatus for reducing the intensity of hurricanes are described herein. A method may include positioning a fleet of submersibles in an area of ocean through which at least a portion of a hurricane's central core will pass within a predetermined amount of time. The submersibles are maneuvered to a depth greater than a depth of a thermocline in this area of ocean. The submersibles maintain their station and depth for a finite amount of time, during which they may release a gas to form bubble plumes which rise toward the ocean's surface. The bubble plumes entrain and upwell cold sub-thermocline water toward the surface of the ocean to cool the surface of the ocean. The cooled ocean surface reduces the intensity of the hurricane whose portion of central core passes through the cooled area. An apparatus to generate a bubble plume may include a gas source, a gas manifold to releasably collect gas from the gas source, and a cover having perforations of a predetermined shape, size, and spacing to produce a predetermined rate of upwelling of seawater. The apparatus may further include a duct to receive at least a portion of the generated bubble plume and channel the cold upwelled seawater toward the surface of the ocean.

This application claims the benefit of U.S. Provisional Application Ser. No. 60/253,111, entitled “Method And Apparatus For Reducing The Intensity Of Hurricanes At Sea By Deep-Water Upwelling,” filed Nov. 28, 2000, which is incorporated herein by reference in its entirety.

### FIELD OF THE INVENTION

The invention relates to the field of hurricane intensity reduction.

### BACKGROUND

The term “hurricane” as used herein refers to any tropical storm system with a sustained wind speed of at least 74 miles per hour (equivalent to 64 knots, 119 km/hr, or 33 m/sec). Such tropical storms are variously referred to as “hurricanes” in the Atlantic Ocean, “typhoons” in the western Pacific Ocean, and “tropical cyclones” or simply “cyclones” in the Southern Hemisphere. The single term “hurricane” as used throughout this report should be understood to refer to any tropical storm anywhere in the world, regardless of what it is called in the region where it occurs. Furthermore, it should be understood that this invention applies to all stages of tropical storm development, including the earliest formative stages, even though the preferred application may be to those storms that have reached close to their maximum potential intensity while at the same time presenting a significant threat to populated coastlines.

The problem addressed by this invention is immense in terms of human and economic losses; a single major hurricane can cause thousands of deaths and/or billions of dollars in economic damage. All available evidence suggests that the east coast of the United States faces two to three decades of hurricane activity comparable to that experienced from the 1920s through 1950s. Given the increases in coastal population and property values since that period, it is estimated that if the hurricane landfall pattern from 1926 through 1955 was to repeat itself in the first decades of the 21st century, the insurance industry might face a claim rate averaging nearly $12 billion annually for 30 years. Moreover, there is a 1-in-8 risk that losses in a single year could exceed $50 billion.

Because tropical storms draw their energy from the heat content of the upper ocean, it is generally accepted that a large area of cooled ocean surface can suppress hurricane intensity. Numerical modeling studies at the Massachusetts Institute of Technology suggests that reduction of sea surface temperature by 2.5° C. in the storm's central core would eliminate the thermodynamic conditions that sustain hurricanes. Other numerical model studies by independent researchers corroborate these results. In addition, analyses of measurements from past hurricanes show a strong correlation between lack of hurricane intensification and conditions that favor cold-water upwelling by the storm's own winds, such as a shallow thermocline or slow forward speed. Finally, there is clear evidence that hurricanes weaken (or do not intensify under otherwise favorable conditions) when a hurricane crosses the cold “wake” of a previous storm.

This application discloses inventions for the artificial upwelling of deep, cold seawater to create an upper ocean area of sufficiently low temperature and large enough size to physically realize the same intensity reductions as predicted by numerical models and as observed when hurricanes are exposed to natural cold water upwelling. The discoveries, concepts, and novel combinations of methods disclosed herein collectively represent the first known invention for reducing hurricane intensity by artificially upwelling deep, cold seawater in the path of any hurricane, at any time and at any place where sufficiently low water temperatures exist beneath the warm upper layer of the ocean.

The physics of natural and artificial hurricane intensity control appear to be governed by sea surface temperature (SST) and the thermal structure (density stratification) of the upper ocean. These influences are combined into a single parameter, Hurricane Heat Potential (HHP), which is used by meteorologists to quantify the heat energy in the upper ocean that is available to fuel a tropical storm. Since SSTs less than 26° C. typically cannot support hurricane development, HHP is defined as the heat content in excess of 26° C. typically per unit area of the underlying water column between the sea surface and the depth of the thermocline. All such excess heat in this layer of water can be readily mixed from top to bottom by hurricane winds and is thus available to fuel the storm's atmospheric convection. A discussion of the scientific basis for hurricane intensity control, which includes discussions on: formation, development, and features of tropical storm systems; natural processes that limit hurricane intensity; and sea surface temperature and hurricane heat potential; and the definition of hurricane interception regions may be found in section 2.0 of Provisional Application Ser. No. 60/253,111 filed Nov. 28, 2000 titled “Method and Apparatus for Reducing the Intensity of Hurricanes at Sea by Deep-Water Upwelling.”

The geographic extent of United States coastline potentially exposed to major hurricane landfall extends from the Texas/Mexico border to Cape Cod, Mass., representing a coastal stretch of 5,000 km. Moreover, there is strong decade-to-decade variability on where such storms come ashore, so that any type of fixed upwelling system may have to cover the entire distance and yet might remain completely unused for years at a time.

### BRIEF DESCRIPTION OF THE DRAWINGS

The various features of the invention will best be appreciated by simultaneous reference to the description which follows and the accompanying drawings, wherein like numerals indicate like elements, and in which:

FIG. 1 is a flow chart illustrating a method of reducing the intensity of a hurricane;

FIG. 2 illustrates a stationary hurricane interception strategy;

FIG. 3 illustrates a maneuver-while-upwelling hurricane interception strategy;

FIG. 4 illustrates a stationary strategy for targeting half of a storm's central core;

FIG. 5 illustrates a maneuver-while-upwelling strategy for targeting one half of a storm's central core;

FIG. 6 illustrates a maneuver-before-upwelling method strategy for targeting one-half of a storm's central core;

FIG. 7 illustrates one apparatus to collect liberated gas from any source in such a way that this gas may be released as a stream of bubbles of approximately the same diameter;

FIG. 8 illustrates one embodiment of a partial airlift duct deployed during upwelling operations;

FIG. 9 illustrates a collapsible embodiment of a partial airlift duct;

FIG. 10 illustrates another embodiment of a partial airlift duct;

FIG. 11 shows ocean temperature 1100 and velocity 1102 profiles as a function of depth measured during Hurricane Gilbert in 1988;

FIG. 12 illustrates an All-Function Submersible;

FIG. 13 illustrates a Carrier Delivery Submersible;

FIG. 14 illustrates an alternate embodiment of the Carrier Delivery Submersible;

FIG. 15 illustrates a Towing Delivery Submersible; and

FIG. 16 illustrates one embodiment of a submersible receiving a charged gas storage and release vessel via a downhaul mechanism.

### DETAILED DESCRIPTION OF EMBODIMENTS OF THE INVENTION

Calculations disclosed herein reveal that compared to a stationary strategy, the total volume of upwelling water may be reduced by using a fleet of mobile, self-powered submersibles initially staged around the 24-hour forecast storm position, distributed across an ocean area comparable to the mean position forecast error. After upwelling is initiated, the submersibles may maneuver closer together as the storm approaches and its forecast position becomes more precisely known. Additional calculations reveal that the total upwelling volume may also be reduced by delaying the onset of upwelling until after the submersibles have maneuvered into position, concentrating their numbers in an area comparable to the size of the hurricane's central core. Furthermore, the submersibles may achieve their objective by cooling just half the ocean area beneath the storm's core. This unbalances the air-to-sea heat flux, resulting in asymmetric eye-wall convection, which in turn could make the hurricane more susceptible to disruption by atmospheric wind shear. To cool half the core, the submersible fleet can be concentrated in an even smaller area, further reducing the total upwelling water volume. Since the source of energy for water upwelling may be gas liberated at undersea pressures, reduction of total upwelling volume leads to fewer and smaller submersibles and consequently lowers capital costs.

The four hurricane interception strategies described above can be practically implemented using several possible combinations of artificial upwelling method and gas liberation method to generate bubble-driven, upward vertical flow of cold, deep seawater. These possibilities are summarized below.

Exemplary upwelling methods, such as ducted airlift pumps, and free bubble plumes are presented herein. These two methods have never been used for the open-ocean, upper water column environment where hurricane interception tactics may be employed. Consequently, two new inventions were developed for this environment: a novel combination of free bubble plumes with partially ducted airlifts, and a hooded manifold for gas collection and bubble release.

Any number of gas sources and/or liberation methods may be used for the upwelling ocean water in accordance with an embodiment of the invention. Some methods and/or sources include, by way of example only: (1) compressed air cylinders, (2) hydrogen and oxygen gas liberated by seawater electrolysis, (3) naturally occurring seafloor deposits of methane hydrate, (4) liquid carbon dioxide, (5) liquid nitrogen, (6) artificial nitrogen hydrate, and (7) pressurized glass micro-spheres or (8) hydrolytic metal particles imbedded in a polymer matrix designed to dissolve at a specific rate in seawater and to have a density such that the polymer-microsphere or polymer-metal combination is neutrally buoyant. The advantage of methods (7) and (8) is that the buoyancy of the submersible may not change as gas is liberated during the upwelling process, possibly eliminating the need for a submersible ballast system to make up for lost gas weight. Another gas liberation method (9) employs a self-agitating Pachuca tank to enhance gas evolution from a suspension of hydrolytic metal particles.

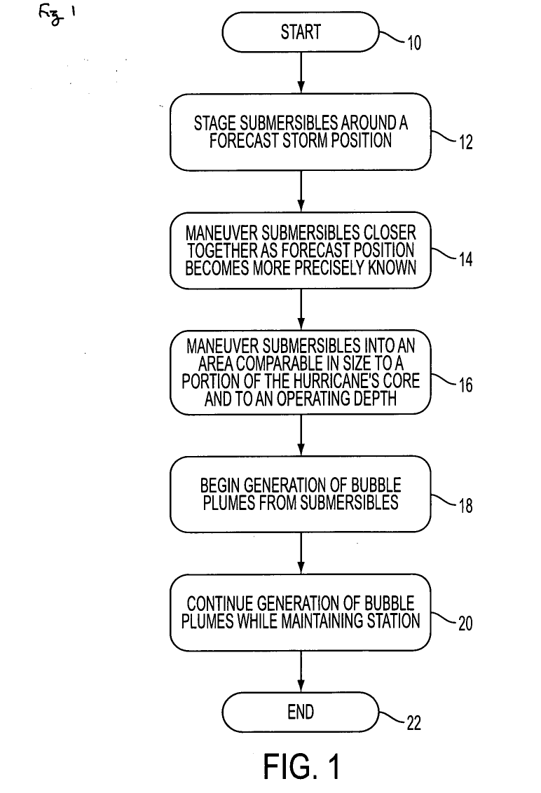

FIG. 1 is a flow chart illustrating a method of reducing the intensity of a hurricane. The method may start at step 10. At step 12, a plurality of mobile self-powered submersibles may be staged around a forecast storm position. The forecast storm position may be, for example, the 24-hour forecast storm position. This is a position where the storm is expected to be in 24 hours following the forecast. The plurality of submersibles may be distributed across an ocean area comparable to the mean position forecast error. At step 14, the plurality of submersibles may maneuver closer together as the storm approaches and its forecast position becomes more precisely known. Maneuvering may occur over a period of hours. For example, maneuvering may occur over a period of 18 hours during which time the storm is closely monitored and its forecasted positional track is updated. At step 16, the plurality of submersibles may maneuver to congregate into positions within an area comparable to the size of the hurricane's central core or even smaller. In one exemplary embodiment described herein, the submersibles may maneuver into an area comparable to the size of one half of the hurricane's central core. Furthermore, while in this area, the submersibles may maneuver to a depth that is below the thermocline, if the submersibles are not already as such a depth. The thermocline is a layer in the ocean that sharply separates regions having different temperatures. At step 18, after the submersibles are in the position identified in step 16, but before the storm has arrived, each submersible may begin to generate one or more gas bubble plumes. At step 20, the submersibles maintain their position and continue to generate gas bubble plumes as the storm approaches. Gas release may continue until a sufficient volume of water has been upwelled to achieve a predetermined reduction in sea surface temperature or until the storm has passed over the submersibles' positions. Generation of bubble plumes need not be performed continuously. At step 22 the method may end with the hurricane having passed over the cooled ocean surface and thereby having had its intensity reduced.

The text above has provided an example of submersibles being staged in an area over which a hurricane is forecasted to pass within 24 hours and maneuvering over the next 18 hours to positions closer together as the storm approaches and its forecast position becomes more precisely known. This example would leave 6 hours for the generation of bubble plumes. However, nothing herein should be construed to limit the duration of any of these steps to these exemplary periods. For example, generation of bubble plumes may occur over a period of about 3 to about 24 hours.

Ocean surface cooling occurs because each bubble plume entrains cold ocean water and this entrained cold water is upwelled to the surface of the ocean, thus cooling the ocean's surface. A preferred upwelling method is a free bubble plume, hybridized with a partial airlift duct that serves two purposes: (A) it prevents excessive warming of the upwelling flow by unwanted entrainment as the bubble plume rises through warmer water on its way to the surface; and (B) it prevents detrainment of the cold water as the plume encounters the strong density gradient of the thermocline, enabling the upwelled water to penetrate into the mixed layer beneath the hurricane.

Any of the gas liberation methods may use a perforated gas release manifold hood, which has two functions: (A) it traps gas bubbles as they rise from storage vessels within the submersible's hull; and (B) the trapped pocket then loses bubbles through a pattern of [circular] perforations of specific diameter, arrangement, and spacing, designed to achieve the maximum amount of cold seawater entrainment per unit of gas liberated into the rising bubble plume before it enters the airlift duct that helps it reach the surface.

At least three possible types of submersible payload delivery systems are disclosed to implement mobile interception strategies. These embodiments are:

(1) An all-purpose submersible that comprises gas storage vessels, gas release mechanisms, manifold hoods, ballast tanks for buoyancy control, and a submersible maneuvering system, which includes: communications, power supply, propulsion mechanisms, and position/attitude control surfaces.

(2) A carrier delivery system whereby a dedicated maneuvering submersible has fixed “wings” to carry gas storage and release vessels. The ballast system remains in the maneuvering submersible.

(3) A towed delivery system whereby a dedicated maneuvering submersible tows a series of gas storage and release submersibles, which contain ballast tanks for buoyancy control as gas is released.

Any one of the three submersible embodiments could incorporate the two artificial upwelling inventions described earlier, namely (1) a gas collector hood with bubble release manifold and (2) a hybrid free bubble plume with partial airlift duct. Additionally the partial airlift duct could be retracted during submersible maneuvering and then deployed once the submersible is in its upwelling position. Submersibles may be manned or unmanned.

Liquid carbon dioxide (LCO₂) is a preferred gas liberation source, since LCO₂ payloads may require the least containment structure or insulation. This is because CO₂ exists naturally as a liquid at the pressures and temperatures found just below the operating depth of the bubble plumes. Thus, for example, when implementing a mobile hurricane interception method, the AUVs may deploy and maneuver in the depth range of 500-600 m, where CO₂ exists naturally as a liquid. When in position and ready to start bubbling, the AUVs could simply rise to a water depth of 200-300 m, where the drop in pressure and rise in temperature is sufficient to cause the LCO₂ to boil, thereby liberating bubbles into the collector hood. Note that the depth at which the AUV's or other submersibles generate bubble plumes may be referred to herein as the “operating depth,” regardless of the type of gas used to generate the bubble plumes.

Any embodiment of the invention that uses LCO₂ gas liberation can be implemented by the production of LCO₂ at sea, with storage and recharging of gas payloads at the same depth at which the AUVs may deploy and maneuver, where pressures are higher and temperatures are colder than at the sea surface. This concept thus minimizes the structural and insulation requirements for LCO₂ storage aboard the LCO₂ production platform.

Note that environmental concerns about releasing CO₂ into the atmosphere can be completely avoided if CO₂ is produced by liquefying and distilling air using renewable energy resources. Since the CO₂ gas released into the atmosphere from the bubble plumes equals the amount of CO₂ withdrawn from the atmosphere earlier to liquefy it, there is no net increase in atmospheric greenhouse gas concentrations. Moreover, to the extent that renewable energy is used to power the air liquefaction and distillation plant, there would not be a release of CO₂ from fossil fuel combustion. In the tropical open ocean areas where this invention may be practiced, ocean thermal-gradient energy is an abundant renewable energy resource for powering liquid CO₂ production plants.

It is not required for this disclosure to perform a detailed review of the state of the art in ocean thermal energy conversion (OTEC). Sufficient information is given herein to show that the OTEC resource is geographically distributed in a manner coincident with all global regions of tropical cyclone activity, and to document that this technology has been proven at sea, with sufficient research and development already done to establish engineering feasibility at a scale appropriate to the power needs of a liquid CO₂ production and payload recharging platform. Thus, an embodiment of this invention can be entirely ocean-based and self-sustaining in its requirements for energy and raw materials, with no net emission of atmospheric pollutants.

### Calculation of Upwelling Volume

To calculate the total volume of upwelling water required to weaken a major hurricane, the following input parameters may be estimated:

required degree of ocean temperature reduction;

extent of area in which temperature reduction must be achieved; and

temperature of upwelling water.

The paragraphs below explain how each of these parameters may be estimated. These estimates are based on the scientific understanding of hurricane thermodynamics as presented in Section 2 of Provisional Application Ser. No. 60/253,111 filed Nov. 28, 2000 titled “Method and Apparatus for Reducing the Intensity of Hurricanes at Sea by Deep-Water Upwelling.”

Estimate required degree of ocean temperature reduction: It is conservatively assumed that the entire Hurricane Heat Potential within a hurricane interception area should be eliminated. While this assumption is used to be overly cautious, this is not intended to limit the scope of the invention should the entire Hurricane Heat Potential not need to be eliminated. This would result in further increasing the practicality of the invention. For purposes of illustration only, an interception region off the East Coast of Florida was chosen. The East Florida (E Fla) interception area represents the worst-case design environment, having the deepest 26° C. isotherm and the highest average layer temperature. The E Fla interception area has a pre-storm sea surface temperature of 28.8° C., a Hurricane Heat Potential (HHP) layer depth of 70 m, and an average HHP layer temperature of 27.74° C.

Estimate extent of area in which temperature reduction should be achieved: This may be accomplished in a two-step process. The first step may be to identify the region within a hurricane where its atmospheric convection is most sensitive to air/sea temperature differences, because that is where ocean cooling may have its greatest effect. This critical thermodynamic region is located within 1.5 times the radius of maximum winds from the storm center. As the low-level inflow spirals toward the eye, it is cooled and dried by convective downdrafts between rainbands. By the time it reaches the eyewall, the inflowing air is about 2.5° C. cooler than the pre-existing sea surface temperature. It is this temperature difference that drives the enhanced local sea-to-air heat flux, which provides energy to fuel the intense updraft convection of the eyewall. If the depth-averaged temperature of the ocean's mixed layer directly beneath and within this critical eyewall region can be cooled to 26° C., the hurricane's convection will be shut down. Typically the radius of maximum wind (rm) in hurricanes ranges from 20 to 50 km, but for purposes of this estimate, we set rm equal to 60 km, as estimated for Hurricane Gilbert, the most intense Atlantic hurricane on record. Thus, the region to be cooled within the eyewall is a circle having a radius of 1.5×60 km, or 90 km.

The second step in estimating the extent of ocean area to be cooled may involve determining the amount of time available to achieve the desired temperature reduction, and the forecast position error associated with that amount of time. The interception area should be far enough away from the storm to allow adequate time for deployment operations, yet close enough to minimize the extent of the area that must be cooled simply to accommodate position forecast inaccuracies. Thus, it is necessary to know something about the wind and wave conditions as they develop in advance of the storm.

Wind speeds are less than gale force (35 MPH) at a distance of about 8 times the radius of maximum wind (rm) in advance of the storm center. At this distance, significant wave heights are likely to be well below 40% of their storm peak as well. Therefore, for the design scenario of rm=60 km, the “weather window” for deployment of stationary upwelling devices and safe withdrawal of deployment vessels will close when the storm center is within 480 km of the nearest edge of the planned interception area.

For hurricanes threatening the U.S. Atlantic coastline, artificial upwelling tactics are likely to be most successful if attempted just before these storms begin to recurve toward the northeast. This is the time when they are likely to be traveling slowest and therefore most influenced by storm-induced, cold-water upwelling. For this reason, the farthest north interception area proposed has the 34th parallel as its northern boundary, immediately offshore Wilmington, N.C.

Hurricanes south of Wilmington have a maximum credible forward speed of about 26 knots (48 kph), which means that wind and wave conditions could begin to exceed the weather window for deployment operations as early as ten hours before storm arrival. Using the 24-hour forecast position of the storm to plan the interception provides a 2× factor of safety for completing deployment and withdrawing deployment vessels. Thus to implement a stationary hurricane interception strategy, all upwelling devices should be in place and starting to bubble a day in advance of the forecast storm arrival.

Meteorologists have a variety of computer model results to use for guidance in forecasting hurricane track positions. Within the past decade, the 24-hour position forecast errors have generally been between 80 and 120 nautical miles to either side of the observed “best track,” with the official forecast having an error of about 100 nautical miles (180 km). This situation has continued to improve in 1998 and 1999.

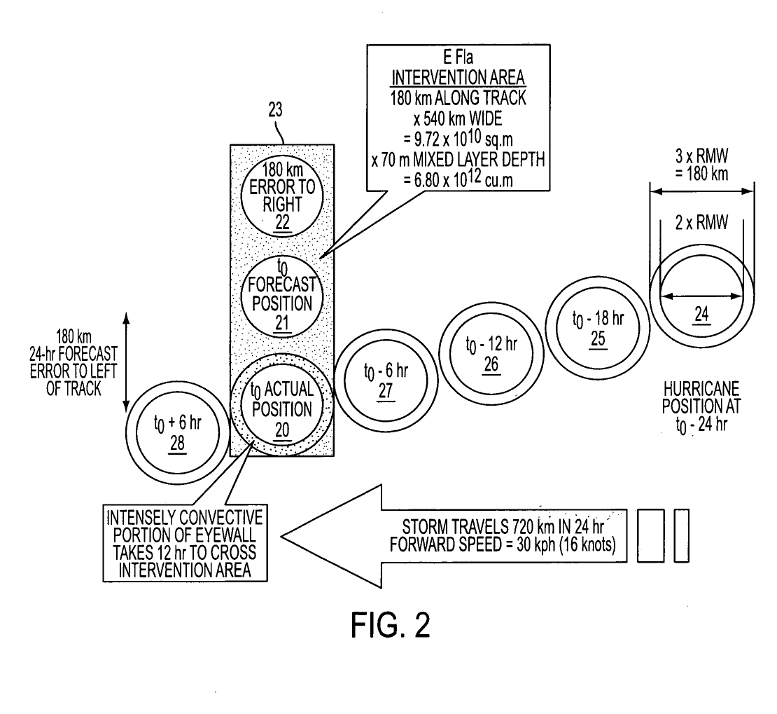

FIG. 2 illustrates a stationary hurricane interception strategy. To ensure that after a 24-hour upwelling period, the eyewall should find itself inside an ocean space that has been cooled to an average temperature of about 26° C., the hurricane interception area should be about 180 km in its along-track dimension, and about 540 km in its cross-track dimension, as illustrated in FIG. 2. FIG. 2 shows the hurricane 20 with its actual center about 180 km to the left of the forecast center 21. Because it has an equal probability of arriving about 180 km to the right 22 of the forecast center 21, the interception area 23 should be about 360 km wide (cross-track), and approximately a further 90 km should be added to either side, so that the eyewall should be covered out to a distance of about 1.5 times the radius of maximum winds (RMW) from the storm center. FIG. 2 also illustrates the hurricane's position at t₀-24 hours 24, t₀-18 hours 25, t₀-12 hours 26, t₀-6 hours 27, and t₀+6 hours 28. In the illustration of FIG. 2, the storm is illustrated as traveling 720 km in 24 hours. This corresponds to a forward speed of approximately 30 kph or approximately 16 knots. In the illustration of FIG. 2, the intensely convective portion of the eyewall takes 12 hours to cross the intervention area.

Thus, in a stationary hurricane interception strategy, a sea surface area of about 180 by 540 km (9.72×1010 m2) should be cooled to a depth of about 70 m, which gives a total volume of about 6.80×10¹² cubic meters. Recall that although the E Fla area has a sea surface temperature of 28.8° C., winds and waves may be expected to fully mix this “skin” temperature to the depth of the 26° C. isotherm by the time the storm arrives. Therefore, upwelling calculations assume that the entire volume has an average temperature of 27.74° C.

Estimate temperature of upwelling water: Numerical modeling results presented below show that the optimal cooling effect can be obtained by free bubble plumes originating at a depth of 300 m below the sea surface. As detailed in that section, the temperature at that depth in the design environment of the East Florida interception area is estimated to be 15° C. Since the rising bubble plumes entrain surrounding seawater from the depths through which they rise, the plume water warms to a temperature of 20.2° C. by the time it reaches the mixed layer above the 26° C. isotherm.

The fraction, f, of the total interception area volume that must be replaced by upwelling water, in order to achieve a final layer temperature of 26° C. is given by the following equation:

f×20.2+(1−f)×27.74=26

where 20.2 is the temperature of the upwelling water, 27.74 is the temperature of the water that it is replacing, and 26 is the desired final layer temperature, all in degrees Centigrade.

Solving the above equation for f indicates that 23% of the total layer volume (6.80×10¹² m³) should be replaced by upwelling water, which amounts to a total upwelling plume volume of 1.57×10¹² m³ over a 24-hour period. This corresponds to a total upwelling rate of 18.2 million cubic meters per second.

### Submersibles Maneuvering While Upwelling

The closer the hurricane is at the time cooling is initiated, the greater the rate of upwelling necessary to achieve a given temperature reduction, but the smaller the likely error in the hurricane position forecast, which reduces the ocean area subject to such upwelling. Compared to the stationary interception strategy, the total volume of upwelling water may be greatly reduced by using mobile, self-powered submersibles initially staged around the 24-hour forecast storm position, distributed across an ocean area encompassing the mean 24-hour position forecast error, just as in the stationary interception strategy described above. The difference in this mobile method is that after upwelling is initiated, the submersibles maneuver closer together, thus, targeting the storm more accurately as the storm approaches and its forecast position becomes more precisely known.

The mean position error for the most skillful forecast models in 1998 was 150 km at 24 hours and 90 km at 12 hours, and this same trend continued in 1999. Thus, when a hurricane is 12 hours away, the required cross-track dimension of the interception area shrinks to 90 km on either side of the forecast position, with a further 90 km added to each side, in order to cover the eyewall out to a distance of 1.5 times the radius of maximum winds from the storm center.

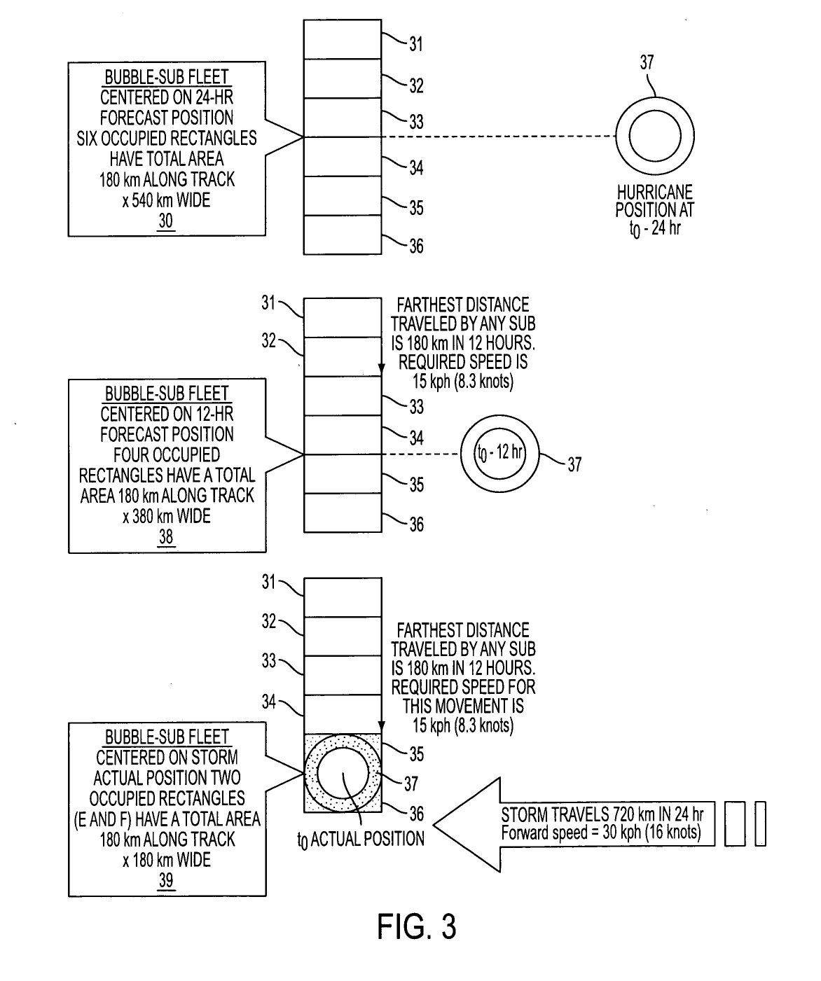

FIG. 3 illustrates a maneuver-while-upwelling hurricane interception strategy. FIG. 3 portrays a storm moving at the same speed and direction as that of FIG. 2. As shown in FIG. 3, a submersible fleet may concentrate itself in a decreasing size interception area until the point the hurricane has reached its along-track 24-hour position, at which time the entire fleet is beneath the eyewall. FIG. 3 illustrates a submersible fleet centered on a 24-hour forecast position 30. That is, the hurricane 37 is positioned 24 hours away from the submersible fleet at time t₀-24, and it is expected to intersect the interception area between Rectangles 33 and 34. At this time, the submersible fleet occupies six rectangles labeled Rectangles 31-36, respectively. These six rectangles 31-36 have a combined total area of 180 km along track×540 km wide. At the 12 hour forecast position 38, the hurricane is expected to intersect the interception area between rectangles 34 and 35. The submersible fleet has maneuvered into positions in rectangles 33-36, respectively. These four rectangles have a total area of 180 km along track×360 km wide. Here the farthest distance traveled by any submersible is 180 km in 12 hours, which corresponds to a required speed of approximately 15 kph or approximately 8.3 knots. The hurricane 37 actually intersects the interception region between rectangles 35 and 36 at t₀. This is the hurricane's actual position 39, at to, is centered along track in the interception area. At the hurricane's actual position, the submersible fleet has maneuvered into positions in rectangles 35-36. These two rectangles have a total area of 180 km along track×180 km wide. Again, the farthest distance traveled by any submersible is 180 km in 12 hours, which corresponds to a required speed of approximately 15 kph or approximately 8.3 knots.

Using such a mobile strategy and a time-stepped calculation of temperature changes in the six sub-area rectangles 31-36, above, the total volume of 20.2° C. upwelling water necessary to achieve a final temperature of 26° C. in Rectangles 35 and 36 (directly beneath the storm at to) was calculated to be 1.02×10¹² m³ over a 24-hour period. This reduces the total upwelling volume requirement to 65% of that required by the stationary strategy and corresponds to a total upwelling rate of 11.8 million cubic meters per second.

### Submersibles Maneuvering Before Upwelling

The total upwelling volume may be reduced further by not upwelling until after the submersibles have maneuvered into position, concentrating their numbers in the area immediately in front of the advancing hurricane. Because the submersibles are maneuvering at a depth of 300 m beneath the sea surface, they are not subject to the extreme turbulence or currents associated with the winds and waves of the storm.

Thus they begin their deployment distributed across six sub-area rectangles 31-36, respectively, as before, but maneuver for 18 hours without bubbling, to follow the track of the storm in near real-time. With appropriate command and control linked to satellite imagery, aircraft fixes, and other real-time data about the storm's position, they continue to concentrate their numbers. Then at t₀-6 hr they start upwelling, at which point they have concentrated their numbers to cover the mean six-hour forecast error, which is assumed to be half the twelve-hour error, namely 45 km to either side of the forecast track.

Again, a time-stepped calculation indicates that bubbling while they maneuver from Rectangles 34, 35, 36 to Rectangles 35 and 36 (to left of forecast track) or to Rectangles 34 and 35 (to right of forecast track), the total volume of approximately 20.2° C. water necessary to achieve a temperature of approximately 26° C. substantially beneath the storm at to was calculated to be 6.30×10¹¹ m³ over a 6-hour period. This reduces the total upwelling volume requirement to approximately 40% of that required by the stationary strategy, a significant improvement over the maneuver-while-upwelling strategy. Since upwelling occurs over a 6- rather than 24-hour period, the total upwelling rate is much greater, corresponding to approximately 29.6 million cubic meters per second.

### Submersibles Targeting Half of Storm Central Core

Although some hurricane simulation programs use a storm model that is symmetrical around a vertical axis, others are able to model asymmetry in the atmospheric convection around the eye. As discussed in Section 2.2 of Provisional Application Ser. No. 60/253,111 filed Nov. 28, 2000 titled “Method and Apparatus for Reducing the Intensity of Hurricanes at Sea by Deep-Water Upwelling,” it has been suggested that the introduction of cross-track asymmetry into a hurricane makes it more vulnerable to atmospheric disturbances. Under appropriate atmospheric conditions, upwelling submersibles can achieve their objective by cooling just half the ocean area beneath the storm's core. This could unbalance the air-to-sea heat flux, resulting in asymmetric eye-wall convection, and this could render the hurricane more susceptible to disruption by regional wind shear, or even the upper-level atmospheric shear caused by the storm's forward motion.

To cool half the core, the submersible fleet may be concentrated in an even smaller area, further reducing the total upwelling volume requirement. This is applicable to all three interception strategies presented above, stationary, maneuvering-while-upwelling, and maneuvering-before-upwelling.

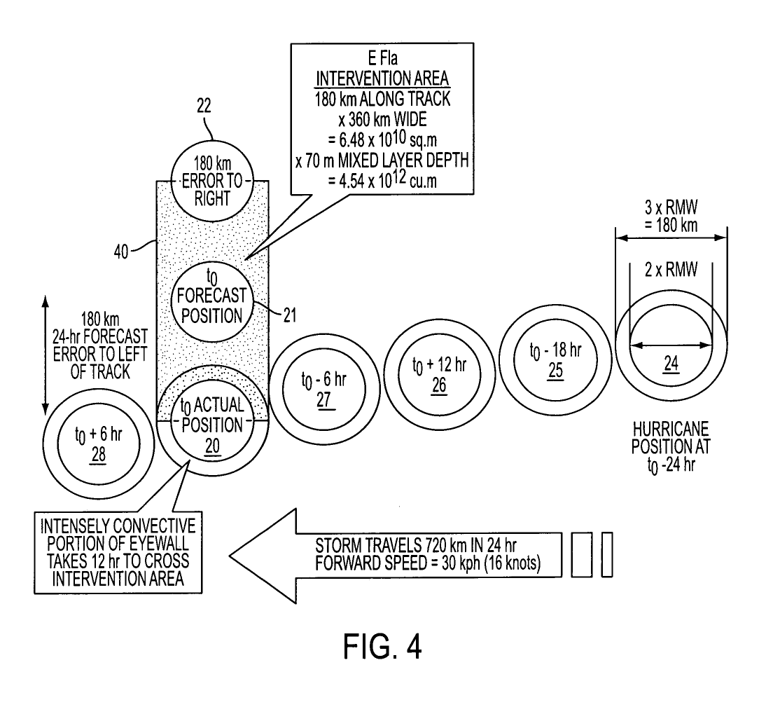

First, consider the stationary interception strategy. FIG. 4 illustrates a stationary strategy for targeting half of a storm's central core. As shown in FIG. 4, targeting half the storm's central core should enable the cross-track dimension to be reduced to 360 km. Thus, the interception area 40, to target half the storm's central core, could be 180 km along track×360 km wide.

Using the same equation as used for the stationary strategy with full-storm target, it is again calculated that approximately 23% of the total layer volume (4.54×10¹² m³) should be replaced by upwelling water, which amounts to a total upwelling plume volume of 1.04×10¹² m³ over a 24-hour period. This corresponds to a total upwelling rate of 12.1 million cubic meters per second.

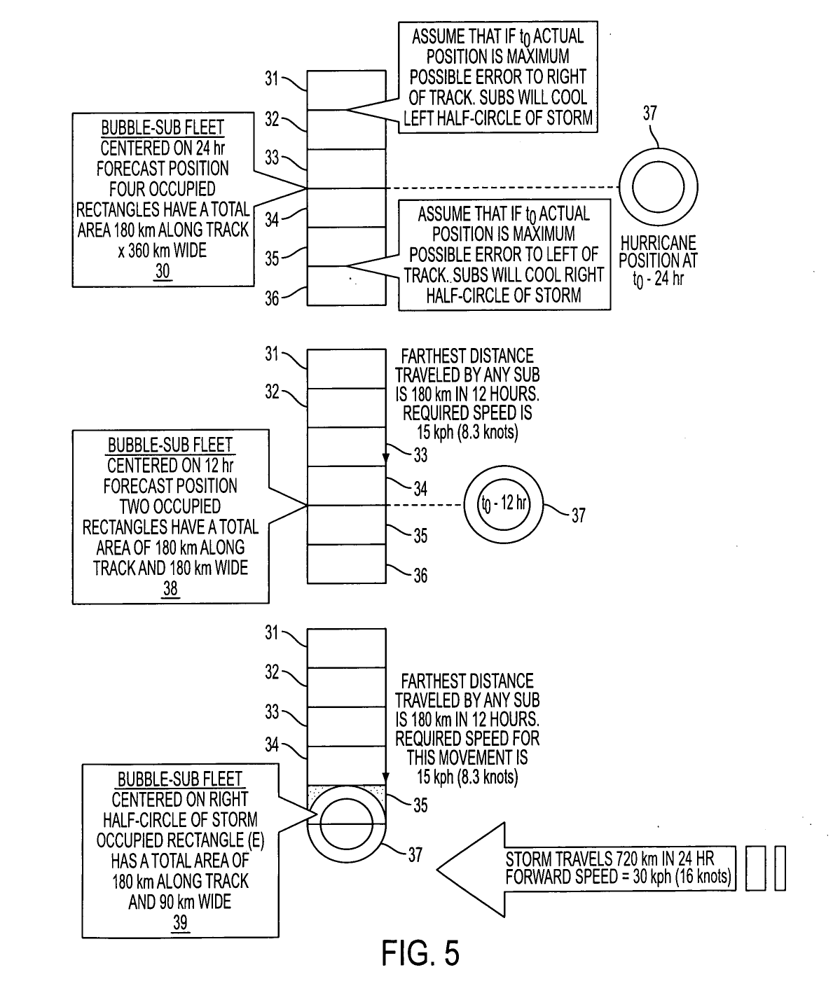

Turning next to the maneuver-while-upwelling strategy. FIG. 5 illustrates a maneuver-while-upwelling strategy for targeting one half of a storm's central core. That is, for targeting just half of the eyewall.

As shown in FIG. 5, a submersible fleet may concentrate itself in a decreasing size interception area until the point the hurricane has reached its along-track 24-hour position, at which time the entire fleet is beneath an area approximately equal to one half of a storm's central core. FIG. 5 illustrates a submersible fleet centered on a 24-hour forecast position 30. That is, the hurricane 37 is positioned 24 hours away from the submersible fleet at time t₀-24, and it is expected to intersect the interception area between Rectangles 33 and 34. If it is assumed that at t₀ the actual position of the storm is the maximum possible error to the right of track, then submersibles in Rectangle 32 will cool the left-half circle of the storm and no submersibles are needed in Rectangle 31. Likewise, if it is assumed that at to the actual position of the storm is the maximum possible error to the left of track, then submersibles in Rectangle 35 will cool the right-half circle of the storm and no submersibles are needed in Rectangle 36. Thus, at the 2-hour forecast position, the submersible fleet occupies four rectangles labeled Rectangles 32-35, respectively. These four rectangles 32-35 have a combined total area of 180 km along track×360 km wide. At the 12 hour forecast position 38, the hurricane is expected to intersect the interception area between rectangles 34 and 35. The submersible fleet has maneuvered into positions in rectangles 34 and 35, respectively. These two rectangles have a total area of 180 km along track×180 km wide. Here the farthest distance traveled by any submersible is 180 km in 12 hours, which corresponds to a required speed of approximately 15 kph or approximately 8.3 knots. The hurricane 37 actually intersects the interception region between rectangles 35 and 36 at t₀. This is the hurricane's actual position 39, at t₀, is centered along track in the interception area. At the hurricane's actual position, the submersible fleet has maneuvered into positions in rectangles 35 alone, in order to target just one half of the storm's central core. Rectangle 35 has a total area of 180 km along track×90 km wide. Again, the farthest distance traveled by any submersible is 180 km in 12 hours, which corresponds to a required speed of approximately 15 kph or approximately 8.3 knots.

Using this strategy and a time-stepped calculation of temperature changes in the four sub-area rectangles 32-35, shown above, the total volume of 20.2° C. upwelling water necessary to achieve a final temperature of 26° C. in Rectangles 32-35 was calculated to be 4.57×10¹¹ m³ over 24 hours. This corresponds to a total upwelling rate of 5.3 million cubic meters per second.

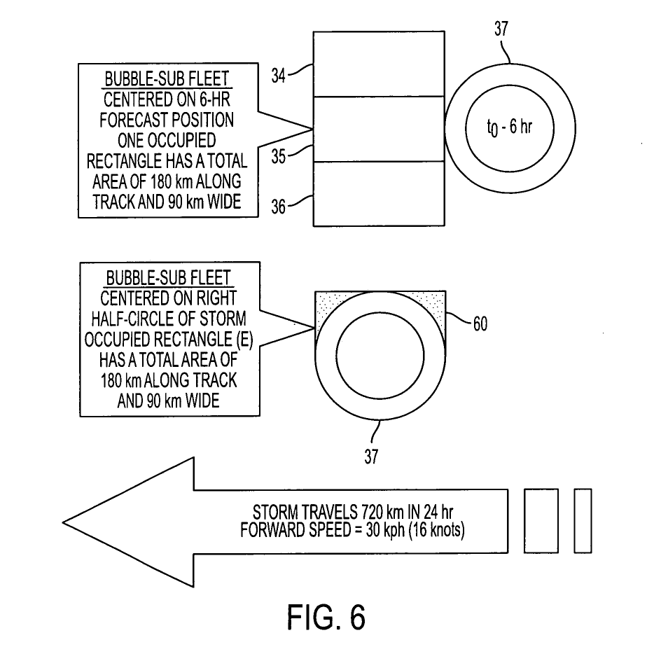

Finally, turning to the maneuver-before-upwelling method, FIG. 6 illustrates a maneuver-before-upwelling method strategy for targeting one-half of a storm's central core. Note that once positioned in Rectangle 35, the submersibles no longer maneuver, they simply initiate upwelling and remain stationary for six hours. If the storm passes to the left of the forecast track, the right half of the storm might be subject to sea surface cooling; if it passes to the right, its left half might be subject to cooling. If the storm does not veer to either the left or right of its forecast track, it might directly overrun Rectangle 35 and not be subject to the asymmetric cooling effect that is the object of this strategy. In this case, the submersibles should migrate to the right side 60 of the actual track, where the eyewall is subject to the most intense natural cooling by the storm's own upwelling energies. In either instance, the area occupied by the submersible fleet is 180 km along track×90 km wide.

The calculation of total upwelling water volume for this strategy uses the same equation as used for the stationary strategy, except that the area of application is only one sub-area rectangle (35) instead of six (31-36), and the duration of upwelling is 6 rather than 24 hours. As before, approximately 23% of the total 70 m layer in the rectangle (1.13×10¹² m³) might be replaced by upwelling water, which amounts to 2.61×10¹¹ m³ over a 6-hour period, corresponding to a total upwelling rate of approximately 12.1 million cubic meters per second.

Note that although this might seem like a stationary interception strategy, it is not. A stationary method may involve deployment of upwelling devices by ship, aircraft, or rocketry. These might sink to the prescribed depth (e.g., 300 m) and then bubble for approximately 24 hours, while the deployment fleet (in the case of ships or aircraft) withdrew. In this case, however, the bubbling submersibles don't arrive at their station until the storm center is six hours away, when wind and wave conditions are far too severe for any sort of deployment from the sea surface. A distinguishing feature of this strategy is the use of self-powered mobile submersibles to “chase” the storm and achieve optimal positioning for effective upwelling.

Since the source of energy for water upwelling is gas liberated at undersea pressures, reduction of total upwelling volume leads to fewer and smaller submersibles and consequently lower capital costs, as well as lower operating costs for the energy needed to supply the gas. As the maneuvering before upwelling and targeting half of the storm methodology results in the smallest total upwelling volume, that method is the preferred method. However, those of ordinary skill will understand that any of the above-identified methods may be suitable for the practice of the invention.

### Integrated Observation, Communication, Command, and Control System (OCCCS)

In order to implement any of the above methods and embodiments regarding different hurricane interception methods, an observation, communication, command, and control system (OCCCS) is desirable. Such an OCCCS may be located on land or may be located on water, such as on a ship or on some other fixed or floating platform. It may integrate satellite imagery of clouds and sea-surface temperatures, aircraft observations of storm eyewall dimensions and position, airborne expendable bathythermograph (AXBT) soundings of ocean thermal structure in storm's path, a system of computer model guidance for hurricane track and intensity forecasting, and an automated command protocol and associated algorithms to control deployment vessels (ships, airplanes, or rocket-launching platforms) in the case of a stationary strategy or to control and/or provide directions to the submersible fleet in the case of a mobile strategy.

A mobile strategy implementation may include real-time command and control of the submersible fleet to keep them cooling the upper ocean in the target area that is most likely to be located beneath the region of weakest density stratification as the hurricane overruns their positions. An example of how this might be done is by continuously deploying AXBTs into the core of the storm and assembling their observations to create a map of the upper ocean thermal structure and how it is distributed underneath the eyewall region. Combining this information with expert-system-based, selective-consensus hurricane track forecasts might then enable the submersibles to continuously target the specific region of the storm where its own natural upwelling energies are greatest and have made it particularly vulnerable to artificial upwelling.

### Artificial Upwelling Methods

The previous section illustrated that one hurricane interception strategy is to maneuver upwelling units into position approximately 6 hours in advance of the storm without initiating upwelling until in position. Wind and sea conditions at this time might be far too severe for operation of pumps or compressors aboard ships or surface platforms. The following text describes an embodiment for entraining sub-thermocline waters in a rising column of bubbles, transporting the rising column across the thermocline density gradient and allowing the entrained sub-thermocline waters to reach a depth near the surface of the ocean.

Useful background material on ducted airlifts, an equation useful in calculating the approximate quantities of gas that a ducted airlift might require to upwell a given volume of water, free bubble plumes, and description of a time domain model used to describe the vertical motion of a bubble plume as it travels through a typical temperature and density profile representative of ocean conditions in the East Florida exemplary hurricane interception region may be found in Section 4 of Provisional Application Ser. No. 60/253,111 filed Nov. 28, 2000 titled “Method and Apparatus for Reducing the Intensity of Hurricanes at Sea by Deep-Water Upwelling.”

It has been discovered that a bubble plume's ability to retain sufficient momentum to “break through” the density gradient depends critically on the size of the bubbling source area and on the initial diameter of the bubbles as they are released from this source. For instance, with a 10-meter diameter source area, a plume with an initial bubble diameter of 10 mm fails to reach the surface, but a 16 mm bubble size is successful, even though both plumes have exactly the same gas flow rate. Similarly, for a 25 mm initial bubble diameter and the same gas flow rate, a plume with a 10 m diameter source area reaches the surface; a plume with a 20 m source area does not.

### Gas Collector Hood with Bubble Release Manifold

The size of the bubbling source area and the initial diameter of the bubbles as they are released from the bubbling source area are important because they relate to the ability of the bubble plume to reach the surface of the ocean. There are a wide variety of gas liberation methods available to provide a source of bubbles to drive either an airlift duct or free bubble plume or a hybrid combination of the two. It is difficult to predict, much less regulate, the size of the bubbles that a particular liberation method might release. For example, the bubbling of liquid nitrogen or solid nitrogen hydrate involves a phase change across an irregular liquid/vapor or solid/vapor interface, and bubbles of all shapes and sizes will be liberated in explosive clusters at some times and in steadier streams at other times. Likewise, surface properties of anodes and cathodes for electrolytic liberation of hydrogen and oxygen will likely yield a variety of bubble sizes and bubbling rates. A different but equally uncontrollable situation occurs with pressurized glass microspheres, since these typically are manufactured in diameters well under a millimeter, which means that the bubble liberated by crushing one may be smaller than optimal for bubble plume upwelling. An apparatus and method is needed that can collect the liberated gas from any source in such a way that this gas may be released as a stream of bubbles of approximately the same diameter.

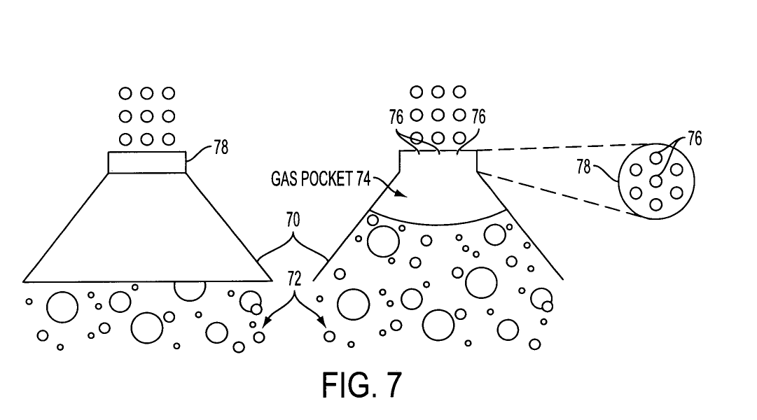

FIG. 7 illustrates one apparatus to collect liberated gas from any source in such a way that this gas may be released as a stream of bubbles of approximately the same diameter. The apparatus includes a collector hood 70 positioned such that it captures bubbles of all sizes 72 as they rise from a gas liberation source (not shown). The inverted funnel shape of the collector hood 70 channels bubbles into a gas pocket that communicates with the overlying water column through a cover 78. The cover defines a release surface having a predetermined cross-sectional area. The cover 78 may have perforations 76 that are of specific diameter and spacing so as to release the optimal bubble size in the optimal flux density and at the optimal rate to accomplish successful plume upwelling with the minimum volume of gas per unit of upwelling water volume. A top view of the exemplary cover 78 illustrates the uniformity of the perforations 76. The collector hood or manifold may collect gas from a plurality of gas sources and channel the collected gas into the gas pocket 74. The embodiment of FIG. 7 is presented for illustration. While the exemplary embodiment of FIG. 7 is illustrated as having an inverted funnel shape, any shape capable of forming a gas pocket may be used without departing from the scope of the invention. Nothing disclosed herein should be construed as limiting the physical shape of the collector hood 70 or cover 78. For example, the cover can be any shape having perforations 76 designed to produce optimal entrainment of seawater into the bubble plume generated by the passing of gas through the perforations in the cover. The perforations 76 need not be circular and need not be uniformly arranged.

### Hybrid Bubble Plume with Partial Airlift Duct

Even with the collector hood and bubble release manifold described above, it is still possible that a free bubble plume in the deeper ocean cannot achieve the same water/air flow ratios as have been achieved in shallower lakes and reservoirs. On one hand, deeper depths give such plumes added energy due to greater isothermal bubble expansion; on the other hand, plume entrainment (and associated momentum loss) occurs over a correspondingly greater distance. Furthermore, density stratification is typically much greater in the ocean than in fresh water lakes or reservoirs.

Both of these deep-ocean obstacles (momentum loss from added entrainment and more severe density gradients) may be overcome by using a partial ducted airlift. Such a partial ducted airlift would experience lower drag forces than a full airlift duct that extends the entire distance from the deep cold-water source to the mixed layer above the thermocline.

Therefore a hybrid bubble plume with partial airlift duct may be comprised of a gas source coupled to a bubble release manifold, wherein, at some height above the bubble release manifold, the bubble plume may be “collared” by a partial airlift duct, preventing further entrainment and also preventing detrainment before it rises into the mixed layer. This may be straightforward to model on a computer without undue experimentation by having a depth range where the numerical entrainment coefficient is zero and where a wall friction term can be introduced. Physically, it may require a wide conduit (or bundle of pipes) comparable to the plume diameter. Several options are available for maintaining the position of such a structure to capture the free plume in an open ocean environment. In certain embodiments, a second gas collector hood at the lower end of the conduit may be used. In other embodiments, the upper end of the conduit might be capable of maneuvering into position to capture the bubbles released by the bubble release manifold. In other embodiments, both the second gas collector hood and maneuvering capability might be utilized.

One embodiment of a partial airlift duct might be a substantially vertical cylindrical structure made of reinforced architectural fabric, similar to that used for air-inflated storage shelters on land or lift bags in underwater salvage operations. This structure may or may not contain interior vertical baffles that could divide the upwelling flow into several parallel airlift sections. Parallel airlift sections could improve the water flow rate for a given quantity of gas by creating slug flow instead of bubble flow, which typically is efficient.

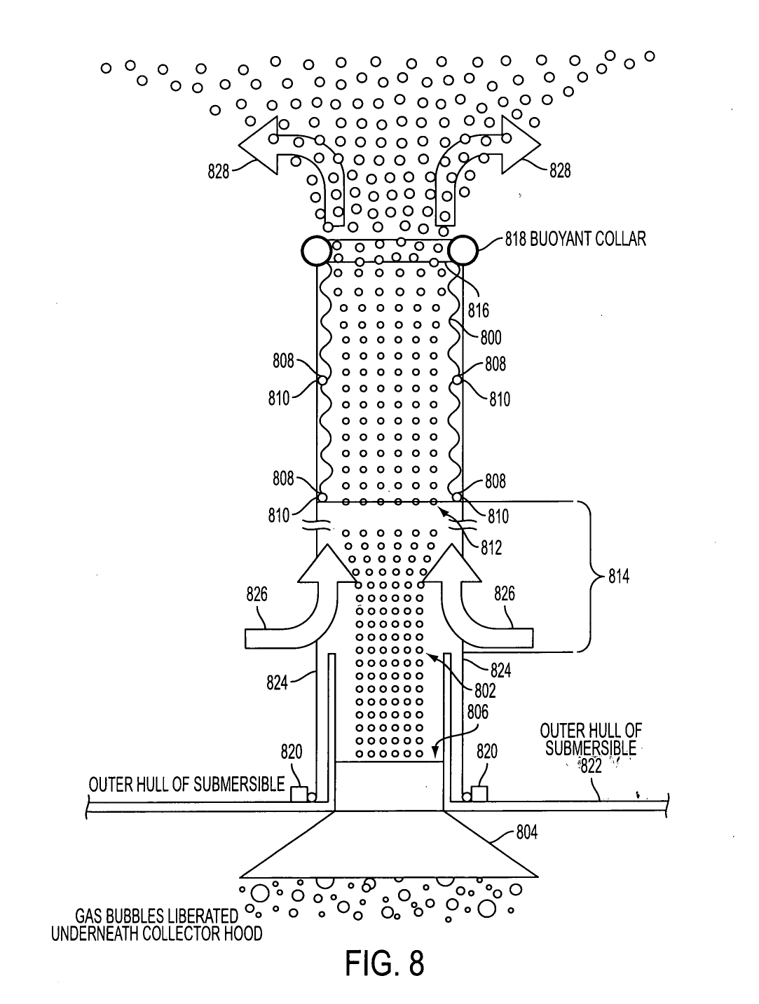

FIG. 8 illustrates one embodiment of a partial airlift duct deployed during upwelling operations. The partial airlift duct comprises a duct 800 to receive at least a portion of a free bubble plume 802. The bubble plume may be released from a collector hood 804, incorporating a perforated cover 806, the perforations having a predetermined shape, size, and spacing to produce optimal entrainment of the surrounding water into the bubble plume. Optimal entrainment will result in the bubble plume substantially reaching the surface such that the volume of water upwelled achieves a predetermined sea surface temperature reduction. The partial airlift duct may include rigid reinforcement rings 808 and wire-rope guides 810. The partial airlift duct 800 includes a first end 812 proximal to the perforated cover 806, the first end 812 retained in a position that is separated from the perforated cover 806, the separation defining a gap 814 to allow deep cold water entrainment into the free bubble plume 802. Large arrows 826 illustrate a path for water to enter the partial airlift duct. Large arrows 828 illustrate a path for water to exit the partial airlift duct. The separation defining the gap 814 may be increased or decreased. The partial airlift duct includes a second end 816 distal to the perforated cover 806. The second end 816 may be coupled to a buoyant collar 818. Winches 820 connected to the hull of the submersible or gas storage vessel 822 may be used to extend or retract cables 824 for the extension and retraction of the buoyant collar 818 and first end 808 of the partial airlift duct 800.

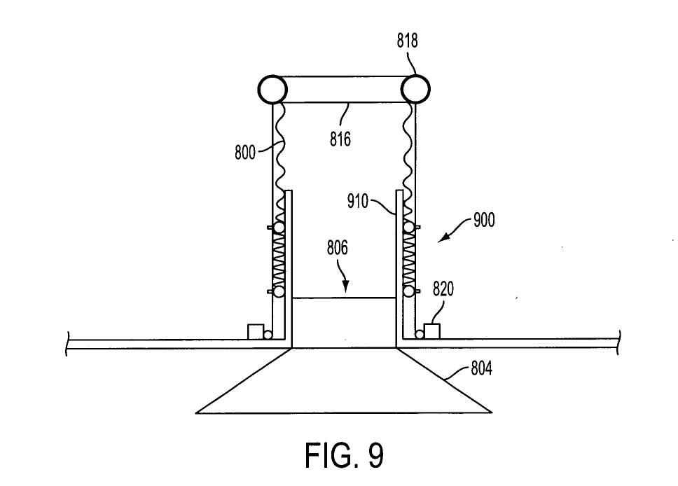

FIG. 9 illustrates a collapsible embodiment of a partial airlift duct. As shown in FIG. 9, the partial airlift duct 800 may be collapsible, much like a “Chinese lantern” so that in its retracted state 900 it would have a low profile, enabling the submersibles to maneuver into their storm interception position with minimal resistance. Once the duct is deployed its second end 816 may be held up and open by a buoyant, flotation collar 818. Winches 820 may be used to deploy the duct 800 prior to initiating gas flow and bubble release. The same winches 820 may be used to retract the duct 800 after bubbling ceases, and the submersible is ready to return to base. A receiving collar 910 may be provided for storage of the collapsed partial airlift duct 800. The receiving collar 910 may be a right circular cylinder or other shape that assists in alignment or collapse of the partial airlift duct 800.

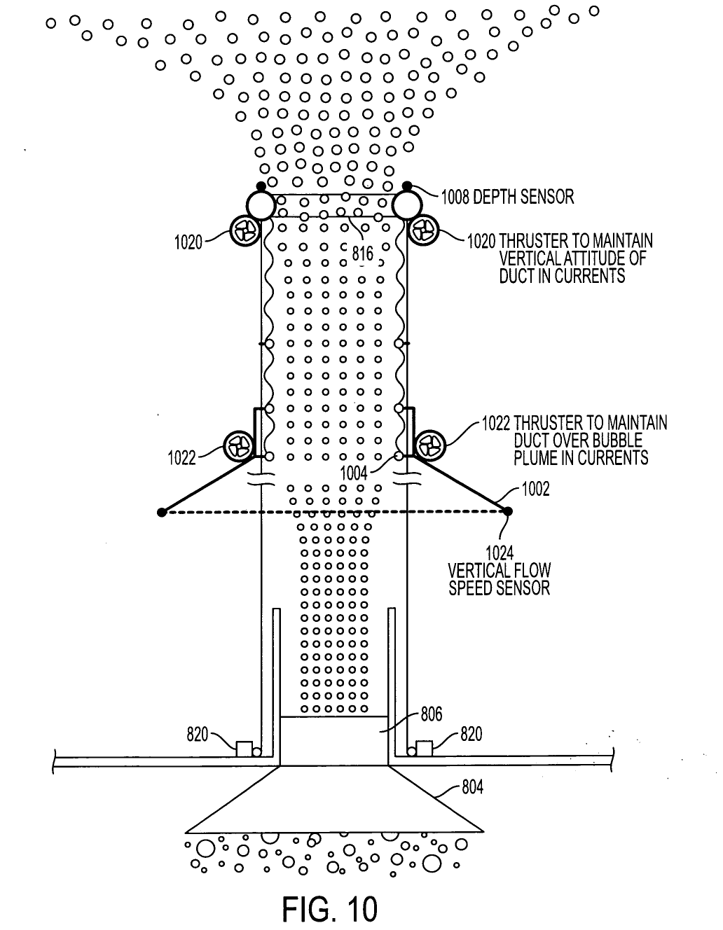

FIG. 10 illustrates another embodiment of a partial airlift duct. To ensure that the partial airlift duct 1000 captures as much of the upwelling flow as possible, a second bubble collector hood 1002 may be fitted to the first end 1004 of the duct 1000. This second bubble collector hood 1002 is similar to the gas collector hood previously mentioned. It has two benefits:

As water is entrained into the free bubble plume, its diameter grows. Turbulence and isothermal expansion of bubbles causes the bubbly core of the plume also to grow in diameter. Having a second bubble collector hood 1002 at the first end 1004 of the duct 1000 captures these bubbles so they can continue to power the upwelling flow through the duct.

The balance of buoyant forces (due to bubbles) and drag forces (due to upwelling flow velocity) on the inverted funnel shape of the second bubble collector hood 1002 may create a net force vector that tends to keep the bottom of the airlift duct centered in the high-velocity, bubbly core of the free plume 1006 as it meanders from side to side under the influence of deep ocean currents.

Maintaining the position of the partial airlift duct 1000 over the bubble plume presents a consideration, particularly if there is a large separation between the submersible and the first end 808, 1004 of the duct, enabling deep ocean currents to deflect the plume sideways. Moreover, there may be significant drag forces on the second end 816 of the duct, because it could be exposed to strong wind-driven currents in the mixed layer. These might deflect the flotation collar 818 so much that unless the winches 820 pay out more cable 824, the second end of the duct 816 may be pulled below the thermocline, defeating its intended objective. Finally, wind-driven currents in the mixed layer typically flow in a different direction than the deeper currents below the thermocline; this difference might tilt the duct 800, 1000 so that it is no longer substantially vertical, reducing airlift efficiency as bubbles impact the tilted inside wall of the duct 800, 1000.

FIG. 10 illustrates a partial airlift duct 1000 with thruster control to counteract the effects of currents. Thrusters 1020 could be installed around the flotation collar 818, enabling the top of the duct 816 to be moved horizontally. A similar array of thrusters 1022 could be spaced around the collector hood 1002 at the bottom of the duct 808, 1004 enabling it to be moved horizontally as well. Other thruster arrays (not shown) could be provided along the length of the duct, to maintain the duct in a substantially vertical position with respect to the bubble plume. Each thruster array 1020, 1022 could have environmental sensors, such as a vertical flow speed sensor 1024 and programmable logic controllers (not shown) that could use different position-keeping algorithms depending on whether the thruster array 1020, 1022 array is at the top or bottom of the duct. These algorithms are described in detail below.

The top-thruster array 1022 could be controlled by data from hydrostatic pressure sensors (depth sensors) 1008 mounted so as to measure the water depth at four points equally spaced around the flotation collar. If the depth difference between two sensors located on opposite sides of the collar exceeds a certain value, it could mean that the duct is being deflected at an excessive angle in the vertical plane that contains those two sensors. The two thrusters located at approximately a 90-degree offset from the vertical plane of deflection could be signaled to move the top of the duct in such a direction so as to decrease the depth difference between the two sensors to within specified limits. The remaining two depth sensors 1008 could measure the deflection component in a vertical plane perpendicular to the plane containing the first sensor pair and could be controlled in a similar manner. This algorithm is intended to ensure that the duct retains an attitude that is close to vertical, thereby maintaining the most efficient airlift flow. Of course, other combinations of sensors and/or thrusters are acceptable.

Using the same pressure sensor data, a different algorithm could be used to control the winches that pay out the wire rope cable 824 by which the partial airlift duct is deployed from the submersible hull. Data from all four sensors might be averaged and combined with AXBT data from the OCCCS to calculate, for example, the density of the overlying seawater and thus the absolute depth of the flotation collar. The cable winches 820 could pay out additional cable 824 as needed to accommodate the horizontal offset imposed by current drag and maintain the upper end of the duct above the thermocline at approximately the specified depth within the mixed layer.

Note that because the winches 820 and their power supplies are likely to be quite heavy, they may be installed on the submersible. This could permit the flotation collar 818 to be much smaller since it only would have to support the weight of the fabric duct 800, 1000, the winch pay-out cables 824, and the bubble collector collar 1002 (if any) at the bottom of the duct. The winch pay-out algorithm may be hard-wired or may be controlled remotely via the OCCCS.

A different algorithm might control the thruster array 1020 at the bottom of the airlift duct. Since the object of this thruster array 1020 is to position the duct over the maximum upwelling flow of the bubble plume, it may be controlled by vertical flow sensors (time-averaged to filter out turbulence) that may, for example, measure the mean upwelling flow rate at four points around the perimeter of the collector collar. If the upwelling flow speed difference between two sensors on opposite sides of the duct exceeds a certain value, it may mean that the side with the lower-speed sensor is closer to the edge than the center of the bubble plume. In this embodiment, the two thrusters located at a 90-degree offset from the vertical plane of deflection could be signaled to move the bottom of the duct in such a direction so as to decrease the flow speed difference between the two sensors to within specified limits. The remaining two flow sensors could be positioned to measure duct movement away from the plume in a vertical plane substantially perpendicular to the plane of the first sensor pair and could be controlled in a similar manner. This algorithm is intended to ensure that the duct remains centered where the upwelling flow is at a maximum within the bubbly core of the plume. Other algorithms may accomplish the same result.

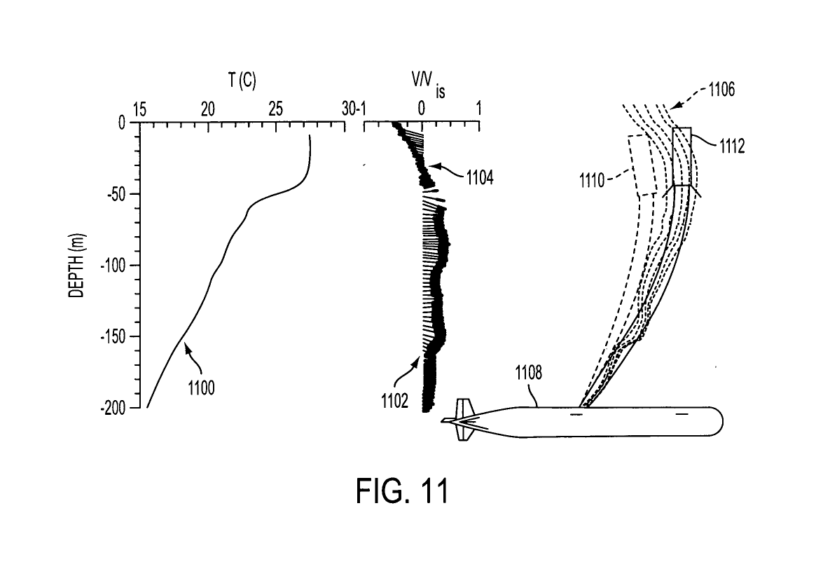

FIG. 11 shows ocean temperature 1100 and velocity 1102 profiles as a function of depth measured during Hurricane Gilbert in 1988. Note the reversal of current direction at the base of the thermocline 1104. The right side of FIG. 11 provides a schematic representation of a bubble plume 1106 rising from a mobile submersible 1108. The plume 1106 path up through the water column is represented by the dotted lines. The heavy dashed rectangle represents what might be expected of a partial airlift duct deployed without any of the position and attitude control embodiments 1110 described above. The suspended catenary weight of the wire-rope cables that tether the duct to the submersible 1108 provide a horizontal force that resists the drag of deep ocean currents, but there is no such constraint on the bubble plume, so it is carried farther away by the currents. The solid rectangle represents an airlift duct that incorporates the position and attitude control embodiments 1112 shown in FIG. 10 and described with reference thereto. FIG. 11 illustrates how position and attitude control embodiments may help the duct 1112 be more effective in carrying the upwelling flow through the thermocline.

The embodiments shown herein are by way of example only. In particular, the partial airlift duct could be as short as a few tens of meters, with a large separation between the bottom of the duct and the bubble plume source, or as long as 200-250 meters, with only a tens-of-meters separation between the duct's bottom and the top of the submersible. Again, these ranges are meant as examples only and are not intended to limit the possible ranges of airlift duct length or separation between the duct and the submersible.

Nothing in this section should be interpreted to limit these inventions in terms of geometry, dimensions, numbers, or arrangements. For example, the cross-sectional area of the gas collection hood and bubble release manifold, as well as the partial airlift duct, could be square or rectangular without diminishing the utility of these inventions. In an embodiment there could be multiple gas collector hoods, multiple bubble release manifolds, and partial multiple airlift ducts installed on a single submersible. In other embodiments, a single gas collector hood could feed multiple bubble release manifolds; a single bubble release manifold could be fed by multiple gas collector hoods, and there could be multiple partial airlift ducts deployed from each bubble release manifold. Additionally, thrusters could include features such as, by way of example only, associated sensors, thruster location and positioning algorithms and the remote control of such thrusters.

### Gas Liberation Methods & Sources

Nine gas liberation methods and sources are described section 5 of Provisional Application Ser. No. 60/253,111 filed Nov. 28, 2000 titled “Method and Apparatus for Reducing the Intensity of Hurricanes at Sea by Deep-Water Upwelling.” The nine gas liberation methods and sources are not meant to be limiting, other gas liberation methods and sources may also be used without departing from the scope of the invention. The nine gas liberation methods and/or sources include: (1) compressed air cylinders, (2) hydrogen and oxygen gas liberated by seawater electrolysis, (3) naturally occurring seafloor deposits of methane hydrate, (4) liquid carbon dioxide, (5) liquid nitrogen, (6) artificial nitrogen hydrate, and (7) pressurized glass micro-spheres or (8) hydrolytic metal particles imbedded in a polymer matrix, and (9) a self-agitating Pachuca tank to enhance gas evolution from a suspension of hydrolytic metal particles.

Of the nine methods and or sources, the preferred embodiment uses liquid carbon dioxide. In the depth range of 500 to 600 m, water temperatures during the hurricane season range from 9 to 11° C., and under these conditions, CO₂ exists as a liquid. This is true as long as it remains out of contact with the surrounding seawater; otherwise it either would dissolve, or if temperatures dropped appreciably, it might form a solid hydrate. All that may be required of a liquid CO₂ payload containment system in this depth range is that it be watertight, furthermore, there may be no need for thermal insulation or high-pressure containment structure to maintain the CO₂ in its liquid phase.

Thus, in any embodiment that utilizes liquid CO₂ as a gas liberation payload, the submersibles could remain at the 500-600 m depth range while waiting for a hurricane to threaten their area of coverage. They also could maneuver at these same depths as they “chase” an approaching storm. Once in position, the submersibles could initiate bubbling by simply rising to the 300-400 m depth range, where water temperatures are approximately 13-15° C. Under these lower-pressure, higher-temperature conditions, CO₂ exists naturally as a gas. Consequently, when the payload containers are opened, the liquid CO₂ interface with the ocean should begin to boil, emitting bubbles that would rise into the collector hood, as described previously.

To calculate the payload effectiveness of this gas liberation source, we assume that a neutrally buoyant material (polymeric or elastomeric) should suffice for fluid containment. In the 500-600 m depths where the submersible payloads might be charged with gas and where the submersibles can wait and maneuver to intercept a hurricane, the liquid CO₂ is expected to have a density ranging from 860 kg/m³ (at 500 m depth, 11° C.) to 890 kg/m³ (at 600 m depth, 11° C.). Using a mean liquid density of 875 kg/m³ for the payload, and recalling that at normal temperature and pressure (NTP), CO₂ gas has a specific volume of 0.544 m³/kg, it is estimated that 476 normal cubic meters of gas can be liberated per cubic meter of liquid, which is thus the payload effectiveness index of liquid CO₂.

Although this is the highest payload effectiveness index among the different gas sources examined herein, there are two potential concerns about using liquid CO₂. From a plume effectiveness point of view, CO₂ gas is orders of magnitude more soluble in seawater than the other gases evaluated herein. For example, at standard temperature and pressure (1 atm and 0° C.), the solubility of CO₂ is 1,460 cc/liter, whereas that for nitrogen is 18 cc/liter. This means that the high gas pressure inside the bubbles at depth will tend to drive the CO₂ into solution, causing loss of bubble volume and consequent loss of upwelling buoyancy.

A second concern is that once the bubbles break the sea surface, they may contribute to the build-up of atmospheric CO₂, a “greenhouse gas” that has been widely implicated as a contributor to global warming. One reference estimates that a 500-megawatt coal-fired power plant produces 540 metric tons of CO₂ per hour, which corresponds to a volumetric emission rate of 7 million Nm³/day. The preferred inventive hurricane interception method of maneuvering before upwelling and targeting half the storm's core, might require a total upwelling water volume of 261×10⁹ m³. On average, a normal cubic meter of gas is capable of upwelling 380 cubic meters of water, based on the results of lake field experiments. This means that any embodiment using liquid CO₂ might release a CO₂ gas volume of approximately 687 million Nm³ in intercepting a single storm, which corresponds to approximately three months of operating a 500-megawatt coal-fired power plant.

Note that environmental concerns about releasing CO₂ into the atmosphere may be avoided by liquefying and distilling air using renewable energy. Since the CO₂ gas released into the atmosphere from bubble plumes would equal the amount of CO₂ withdrawn from the atmosphere earlier to liquefy it in the first place, there would be no net increase in atmospheric greenhouse gas concentrations. Moreover, in another embodiment, if the air liquefaction and distillation plants use renewable energy, there could be no release of CO₂ from fossil fuel combustion. If practiced in the tropical ocean areas, where hurricanes typically are common, ocean thermal-gradient energy is an abundant renewable energy resource for powering liquid CO₂ production. The use of ocean thermal gradient energy for possibly recharging submersible gas payloads is described in Section 6.4 of Provisional Application Ser. No. 60/253,111 filed Nov. 28, 2000 titled “Method and Apparatus for Reducing the Intensity of Hurricanes at Sea by Deep-Water Upwelling.”

### Payload Delivery Methods

Three payload delivery systems using self-powered, manned or unmanned submersibles are illustrated to implement the mobile hurricane interception strategies.

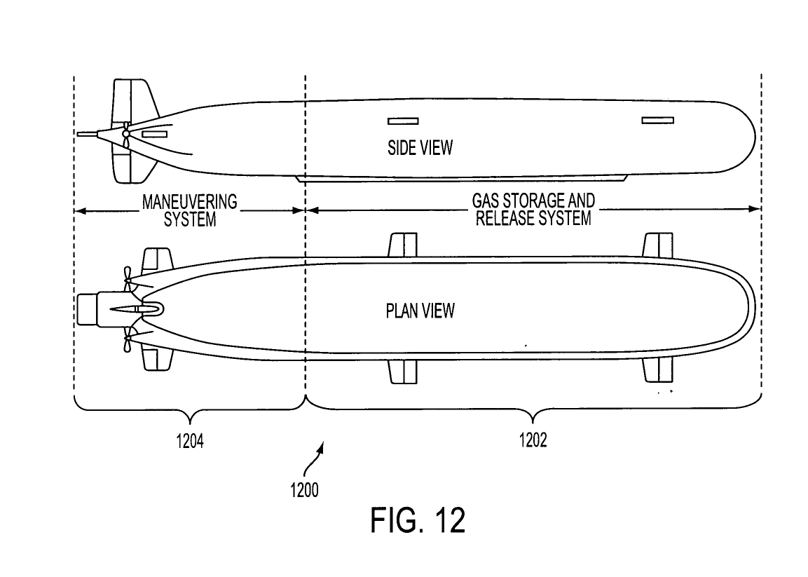

FIG. 12 illustrates an “All-Function Submersible” 1200 that contains a gas storage and release system 1202, ballast tanks for buoyancy control, and the submersible maneuvering system, which comprises communications, power supply, propulsion mechanism, and position/attitude control surfaces. The All-Function Submersible 1200 may carry a gas storage and release system 1202 in the forward part of the vessel and a maneuvering system 1204 in the aft part of the vessel. The gas storage and release system 1202 may comprise any one, or a combination of the following components: gas liberation payload(s), such as liquid carbon dioxide, gas collector hood(s), bubble release manifold(s), and partial airlift duct(s), including any apparatus for free bubble capture and duct position and attitude control. The components just listed are not shown in FIG. 12 for reasons of clarity.

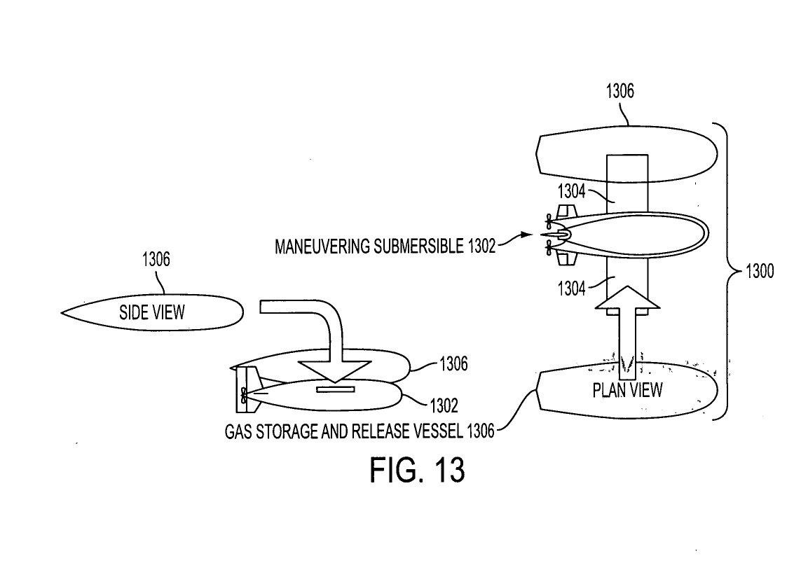

FIG. 13 illustrates a “Carrier Delivery Submersible” 1300 whereby a maneuvering submersible 1302 has fixed “wings” 1304 to carry gas storage and release vessels 1306. The ballast tanks and ballast control system remain in the maneuvering submersible 1302 so that it can carry its payload at appropriate depths. The gas storage and release vessels 1306 may comprise any one, or a combination of the following components: gas liberation payload(s), such as liquid carbon dioxide, gas collector hood(s), bubble release manifold(s), and partial airlift duct(s), including any apparatus for free bubble capture and duct position and attitude control. The components just listed are not shown in FIG. 13 for reasons of clarity.

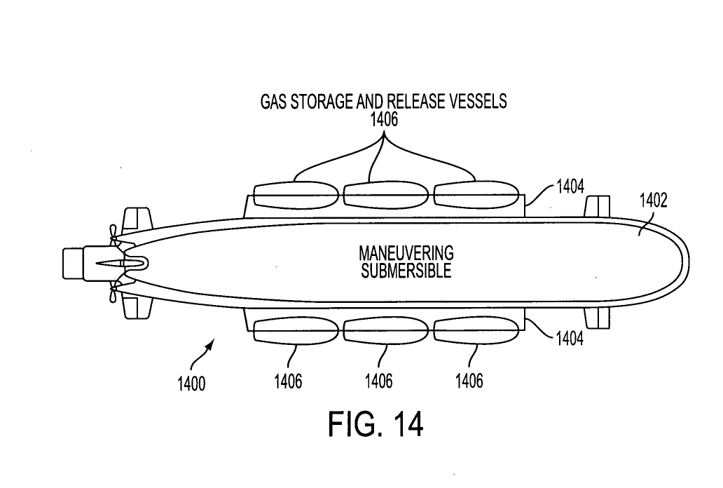

FIG. 14 illustrates an alternate embodiment of the “Carrier Delivery Submersible” 1400. Note that by way of example only, FIG. 13 illustrates a maneuvering submersible 1302 that has a relatively short length and relatively wide wings 1304, resembling an airplane in its hull-length-to-wing-width ratio. This embodiment could just as well be realized by a relatively long maneuvering submersible, such as maneuvering submersible 1402 with relatively narrow wings 1404, resembling long shelves that run along the length of the maneuvering submersible hull, onto which a series of gas storage and release vessels 1406 can be secured.

A characteristic of the embodiments of FIGS. 13 and 14 is that the gas liberation payloads (the gas storage and release vessels 1306, 1406) are not inside the hull of the maneuvering submersible 1302, 1402, but are attached to its hull externally. This avoids the need to recharge the gas payloads through a hose conveyance that would penetrate the hull of the maneuvering submersible. Instead, gas liberation payloads 1306, 1406 may be prepared at a recharging platform, and when the maneuvering submersible 1302, 1402 returns for replenishment, it may offload the empty gas storage and release vessels 1306, 1406 and onload recharged vessels.

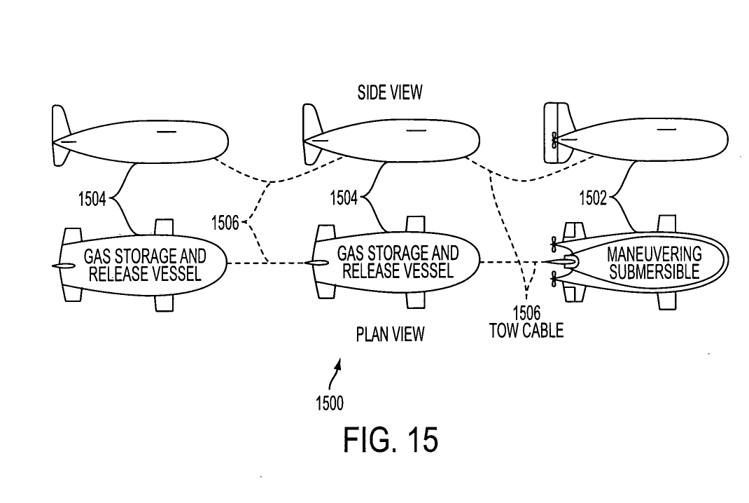

FIG. 15 illustrates a “Towing Delivery Submersible” 1500 whereby a maneuvering submersible 1502 tows a series of gas storage and release submersibles 1504. Each of the gas storage and release submersibles 1504 include ballast tanks for buoyancy control as gas is released. The towed gas storage and release vessels 1504 may comprise any one, or a combination of the following components: gas liberation payload(s), such as liquid carbon dioxide, gas collector hood(s), bubble release manifold(s), and partial airlift duct(s), including any apparatus for free bubble capture and duct position and attitude control. The components just listed are not shown in FIG. 15 for reasons of clarity.

Note that this embodiment may also include the method of towing one or more gas storage and release vessels into position and detaching them from a tow cable 1506, leaving the vessel in proper position to begin bubbling when signaled by the fleet control system. In this embodiment, the gas storage and release vessel might contain its own mooring system (e.g., anchoring cable and deadweight or embedment anchor) to keep the vessel in position while it is bubbling. The towing cable can be assembled from chain, wire rope, or synthetic textile rope, or any combination thereof, or any other material or method or combination of materials and methods suitable for maintaining the gas storage and release vessels in proper position.

Each of these three mobile delivery embodiments are presented, by way of example only. It will be understood that many underwater mobile delivery systems may be used without departing from the scope of the invention. FIGS. 12, 13, 14, and 15 are provided by way of example only. Nothing in these figures should be construed to limit these embodiments to particular shapes, sizes, numbers, or arrangements of propulsion mechanisms and position/attitude control surfaces.

### Recharging of Submersible Gas Payloads

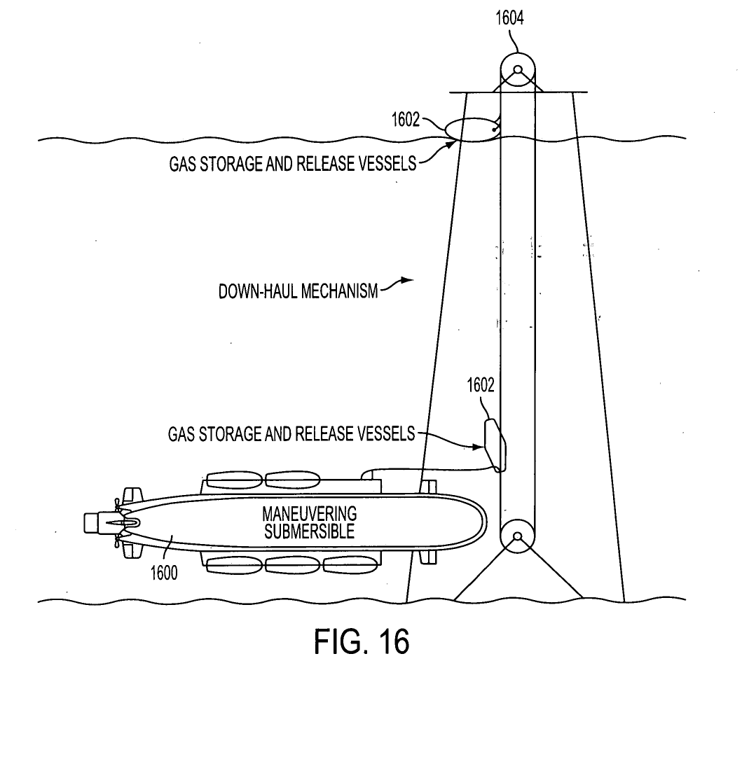

Since carbon dioxide can exist in a liquid state only at elevated pressures and cold temperatures, any embodiment of this invention that uses liquid CO₂ may benefit from the production of liquid carbon dioxide at sea, with bulk storage and recharging of gas storage and release vessels or other submersible at the same depth at which carbon dioxide exists naturally as a liquid. FIG. 16 illustrates one embodiment of a submersible 1600 receiving a charged gas storage and release vessel 1602 via a down-haul mechanism 1604; the gas storage and release vessel having been charged on the surface of the ocean. This method could minimize the internal pressure and thermal insulation requirements for bulk storage of gas liberation payload replenishment materials aboard the payload-recharging platform. It will be understood that the above storage and charging method can apply to any gas liberation source that lends itself to being produced and loaded at sea.

For ocean-broad production of gas liberation payload replenishment materials, energy would be required. Examples include the energy required for air liquefaction in order to distill liquid carbon dioxide, the energy required for seawater electrolysis to produce hydrogen and oxygen, and the energy required for magnesium production from seawater. Furthermore, it will be understood that any ocean-based embodiment of a payload-recycling platform will require energy for its operation. In the tropical ocean areas where stationary payload deployment platforms or mobile submersible fleets might be staged to intercept hurricanes, ocean thermal-gradient energy is an abundant renewable energy resource for powering such production plants.

Ocean thermal energy conversion (OTEC) resources are geographically distributed in a manner coincident with all global regions of tropical cyclone activity. OTEC has been proven at sea, with sufficient research and development already done to establish engineering feasibility at a scale appropriate to the power needs of a submersible payload-recharging platform. Therefore, any method and apparatus for reducing the intensity of hurricanes at sea by deep-water upwelling could be entirely ocean-based and self-sustaining in its requirements for energy and raw materials, with no net emissions of atmospheric pollutants.

The disclosed embodiments are illustrative of the various ways in which the present invention may be practiced. Other embodiments can be implemented by those skilled in the art without departing from the spirit and scope of the present invention.

1. A method of making a reduced intensity hurricane, comprising:
positioning a plurality of submersibles in a hurricane interception area, the hurricane interception area describing an area of ocean through which at least a portion of the hurricane's central core will pass;
maneuvering the plurality of submersibles to a depth;
maintaining the plurality of submersibles in the hurricane interception area at the depth for a period of time; and
releasing a gas from the plurality of submersibles after the plurality of submersibles have entered the hurricane interception area, the gas being released during the period of time, the gas forming bubbles which rise in a plume toward a surface of the ocean, the plume entraining water from at least the-depth and upwelling the entrained water toward the surface of the ocean to cool the surface of the ocean, the cooled surface reducing the intensity of the hurricane whose portion of central core passes through the hurricane interception area.

2. The method of claim 1, wherein the depth is greater than the depth of a thermocline below the surface of the ocean in the hurricane interception area.

3. The method of claim 1, wherein the-period of time is in the range of about 3 to about 24 hours.

4. The method of claim 1, wherein the entrained water is upwelled at a rate, such that the total amount of upwelled water achieves a sea surface temperature reduction.

5. The method of claim 1, wherein a required cross track dimension of the interception area is substantially one half of the diameter of the hurricane's central core.

6. The method of claim 1, wherein the step of releasing occurs after the hurricane's intensification phase has ceased.

7. The method of claim 1, wherein the bubbles are formed at a diameter and rise from a release surface of a cross-sectional area.

8. A method of reducing the intensity of a hurricane, comprising:
staging a plurality of mobile submersibles in an interception area around a forecast hurricane position, the plurality of mobile submersibles distributed across a first distribution area comparable to a mean position forecast error of the forecast hurricane position;
reducing, in accordance with a reduced mean position forecast error as the hurricane approaches the plurality of mobile submersibles, the first distribution area of the plurality of mobile submersibles to a second distribution area; and
generating, after the step of reducing, at least one bubble plume from at least one of the plurality of mobile submersibles, the at least one bubble plume upwelling water from a depth to a surface of the ocean, the upwelled water cooling the surface of the ocean, the cooled ocean surface reducing the intensity of the hurricane.

9. The method of claim 8, wherein the second distribution area is an area between about 30% to about 100% of the size of the hurricane's central core.

10. The method of claim 8, wherein the depth is greater than the depth of a thermocline below the surface of the ocean in the predetermined area.

11. The method of claim 8, wherein the bubble plume comprises bubbles formed at a diameter and rising from a release surface of a cross-sectional area.

12. The method of claim 8, wherein the upwelled water is upwelled at a rate, such that the total amount of upwelled water achieves a sea surface temperature reduction.

13. The method of claim 8, wherein the step of generating occurs after the hurricane's intensification phase has ceased.

14. A method of reducing the intensity of a hurricane, comprising:
positioning a plurality of submersibles below an ocean's surface in an area of the ocean above which at least a portion of the hurricane's central core will pass, the ocean's surface having a sea surface temperature;
generating at least one bubble plume from the plurality of submersibles; and
upwelling water by action of the at least one bubble plume, wherein the water is upwelled at a rate such that the total amount of upwelled water achieves a sea surface temperature reduction at the conclusion of a period of time.

15. The method of claim 14, wherein the plurality of submersibles are positioned below the ocean's surface at a depth greater than the depth of a thermocline.

16. The method of claim 14, wherein the portion of the hurricane's central core is between about 30% to about 100% of the size of the hurricane's central core.

17. The method of claim 14, wherein the period of time is in the range of about 3 to about 24 hours.

18-32. (canceled)

33. The method of claim 1, wherein the submersibles are stationary submersibles.

34. The method of claim 1, wherein the submersibles are mobile submersibles.

35. The method of claim 14, wherein the submersibles are stationary submersibles.

36. The method of claim 14, wherein the submersibles are mobile submersibles.
